(19) United States
(12) Patent Application Publication
(10) Pub. No.: US 2015/0358178 A1
(43) Pub. Date: Dec. 10, 2015

(54) DATA TRANSMISSION ARCHITECTURE, IN PARTICULAR FOR USE IN ON-BOARD AVIONICS

(71) Applicant: THALES, Courbevoie (FR)

(72) Inventors: Patrice TOILLON, Meudon La Foret (FR); Michael TEMPLIER, Meudon La Foret (FR); Gabrielle SAROUILLE, Meudon La Foret (FR); Augustin MIGNOT, Meudon La Foret (FR)

(21) Appl. No.: 14/826,532

(22) Filed: Aug. 14, 2015

Related U.S. Application Data
(63) Continuation of application No. PCT/EP2014/052604, filed on Feb. 11, 2014.

(30) Foreign Application Priority Data
Feb. 15, 2013 (FR) 13 00338

(51) Int. Cl. H04L 12/46; H04L 12/42; B64D 43/00; H04L 12/44

(52) U.S. Cl. CPC H04L 12/4637; H04L 12/44; H04L 12/42; B64D 43/00

(57) ABSTRACT

A data transmission architecture, in particular for use in on-board avionics is disclosed. The data transmission architecture includes at least one main data transmission network with integrated functional nodes for connecting peripheral connecting networks in a data transmission loop to the main network, in order to provide data transmission between the networks.

### CROSS-REFERENCE TO RELATED APPLICATIONS

This application is a continuation of International Application No. PCT/EP2014/052604, filed Feb. 11, 2014, which claims benefit under 35 U.S.C. §119 of French Application No. 13 00338, filed Feb. 15, 2013, which are herein incorporated by reference in their entirety.

### BACKGROUND

1. Technological Field

The described technology generally relates to a data transmission architecture. More specifically, the described technology relates to such a data transmission architecture in particular designed for applications to on-board avionics.

2. Description of the Related Technology

In such applications, in particular to on-board avionics, the equipment is generally distributed into groups to form systems or subsystems.

It is known that the data communication and transmission architectures that were developed in the related technology make it possible, owing to the association of different network topologies, each of which has its own communication mode, to respond optimally to communication needs of the systems.

In particular, these architectures make it possible to provide a response certifying their data exchanges and the interconnections, while maintaining the integrity and availability levels required for each of the systems.

Thus, for example, it is known that in the related technology, there are different data transmission networks, implementing different protocols and that are connected to one another by exchange gateways.

### SUMMARY OF CERTAIN INVENTIVE ASPECTS

One objective of the described technology is to further improve this type of transmission architecture.

To that end, one inventive aspect relates to a data transmission architecture, in particular for use in on-board avionics, including at least one main data transmission network with integrated functional nodes for connecting peripheral data transmission networks in a data transmission loop, to the main network, in order to provide data transmission between the networks.

Other aspects of the architecture can include, considered alone or in combination:
the main network and/or the peripheral data transmission networks include redundant data transmission supports;
the main data transmission network includes switches;
the main data transmission network is a looped network;
the main data transmission network is a star network;
at least one looped peripheral data transmission network assumes the form of a network for the unconditional transmission of messages from node to node, independently of those messages;
at least one looped peripheral data transmission network assumes the form of a network for the conditional transmission of messages from node to node, dependent on those messages;
at least some of the data transmission networks are unidirectional;
at least some of the data transmission networks are bidirectional;
the functional nodes of the peripheral networks connected to the main network comprise a capability for extracting/injecting/monitoring frames from and in the latter, to or from the main data transmission network;
the main network includes several associated sub-networks;
at least some of the functional nodes are programmable;
the frame extracting/injecting/monitoring capability of the programmable node use a programming database stored in a corresponding storage capability;
the main network and the peripheral data transmission networks include data transmission supports that are completely or partially redundant associated by redundancy plane.

### BRIEF DESCRIPTION OF THE DRAWINGS

The described technology will be better understood using the following description, provided solely as an example and done in reference to the appended drawings, in which:

FIG. 1 shows an example embodiment of a data transmission architecture in particular for an on-board avionics application, according to the described technology, and

FIGS. 2 and 3 show example embodiments of functional nodes connected in such networks.

### DETAILED DESCRIPTION OF CERTAIN INVENTIVE EMBODIMENTS

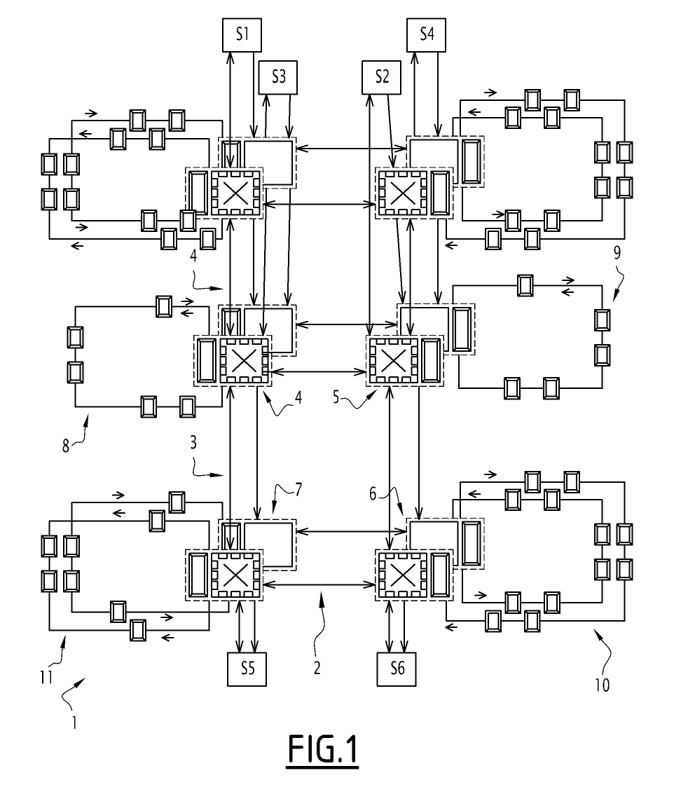

These figures, and in particular FIG. 1, in fact show a data transmission architecture in particular for on-board avionics applications.

This architecture is designated by reference 1 in this figure and then includes at least one main data transmission network, for example designated by general reference 2, in which functional nodes are integrated for connecting looped peripheral data transmission nodes, to that main network, in order to ensure a data transmission between those networks.

Thus for example, the main data transmission network can be a looped or star network.

In the example illustrated in this FIG. 1, the main data transmission network 2 includes looped networks, for example like those designated by reference 3.

This looped network 3 then includes functional nodes for example designated by references 4, 5, 6 and 7, for connecting peripheral networks in a data transmission loop, to that main network 2.

The data transmission peripheral networks are respectively designated by references 8, 9, 10 and 11 in that FIG. 1.

In fact and as illustrated, the main network and/or the peripheral data transmission networks may include redundant data transmission supports associated by redundancy plane.

The main data transmission network 2 may include switches making it possible to transmit data therein.

At least one of the looped peripheral data transmission networks may assume the form of a network for the unconditional transmission of messages from node to node in that network, that transmission being independent of those messages.

However, for example, other looped peripheral data transmission networks may of course also assume the form of networks for the conditional transmission of messages from node to node in that network, that transmission then being dependent on those messages.

Likewise, at least some of the data transmission networks can be unidirectional or bidirectional, the information traveling in one direction or both directions in the network.

One can then see that owing to such a structure, the peripheral communication networks are autonomous relative to one another, the main network seeing to the federation of those various networks and therefore of the different corresponding domains, with respect to the information exchanged between them.

The main or central communication network may be based on a communication technology based on frame switching, using one or more pieces of dedicated avionics equipment of the switch, for example, also referred to as switches, or avionics sub-systems of the distributed switch type.

This essential communication network or domain may for example be based on standards of the Aeronautical Radio, Incorporated (ARINC) 664 or ETHERNET Institute of Electrical and Electronics Engineers (IEEE) 802.3 type.

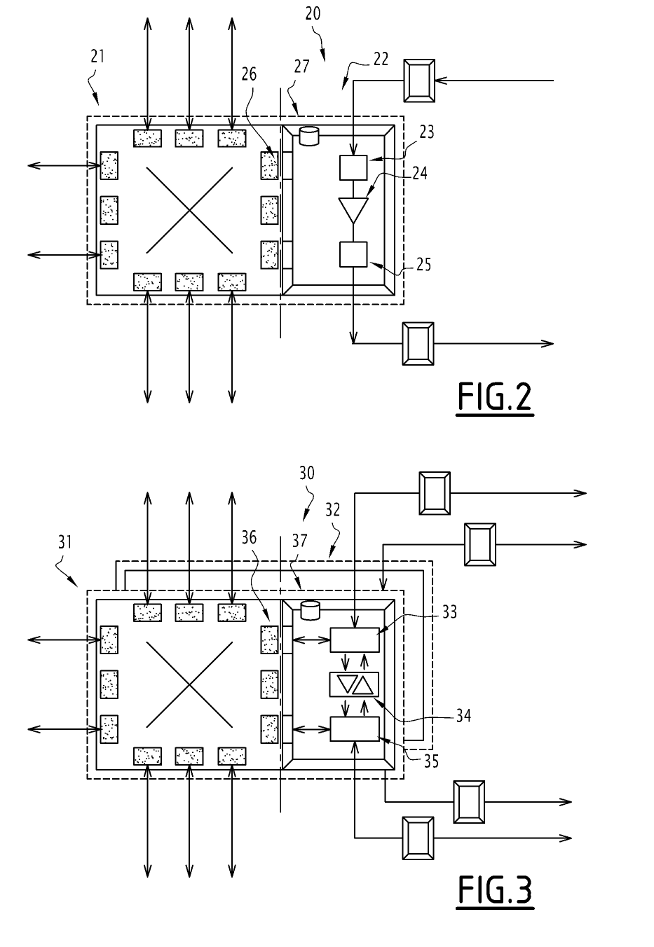

Furthermore and as illustrated for example in FIGS. 2 and 3, the functional nodes of the peripheral networks connected to the main network may comprise a frame extracting/injecting/monitoring capability, to or from the main data transmission network.

These FIGS. 2 and 3 indeed illustrate nodes 20 and 30, respectively, whereof the node 20 is a node for a simple transmission loop, while the node 30 is a node for a double data transmission loop.

It is thus for example possible to show that the main network and the peripheral data transmission networks may each include data transmission supports that are completely or partially redundant, which are then associated by redundancy plane.

Indeed and as illustrated, each node includes a switching part 21 and 31, respectively, for connecting to the main network, and a part including an extracting/injecting/monitoring capability for frames 22 and 32, respectively.

These parts for example include, for each data transmission loop and therefore each plane, frame extraction capabilities 23 and 33, respectively, for the circulation capabilities 24, 34, respectively, and frame injection capabilities 25, 35, respectively.

Monitoring capabilities 26, 36, respectively, are provided between the two parts of the nodes.

Of course, at least some of the connecting nodes may be programmable and these frame extracting/injecting/monitoring capabilities of the programmable node then use a programming database stored in corresponding storage capability, for example an integrated configuration database designated by references 27 and 37, respectively, in these FIGS. 2 and 3.

One can of course see that each configuration table can be modified based on the logic connectivity of the data flows to be exchanged between a peripheral domain or network and the main domain or network.

As also illustrated in FIG. 3, in the case of a peripheral domain with a multi-plane architectures for example with two loops as illustrated, i.e., for example loops called loops α and β, each loop, i.e., each plane is connected to one of the redundant switches, i.e., the loop α is associated with one switch and the loop β is associated with another switch.

This assembly then makes up a redundant overall system with a direct connection from end to end.

Of course, other embodiments may also be considered.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

What is claimed is:

1. A data transmission architecture, in particular for use in on-board avionics, comprising at least one main data transmission network with integrated functional nodes for connecting at least two peripheral connecting networks in a data transmission loop to the main network, in order to provide data transmission between the networks.

2. The data transmission architecture according to claim 1, wherein the main network and/or the peripheral data transmission networks include redundant data transmission supports.

3. The data transmission architecture according to claim 1, wherein the main data transmission network includes switches.

4. The data transmission architecture according to claim 1, wherein the main data transmission network is a looped network.

5. The data transmission architecture according to claim 1, wherein the main data transmission network is a star network.

6. The data transmission architecture according to claim 1, wherein at least one looped peripheral data transmission network assumes the form of a looped network for the unconditional transmission of messages from node to node, independently of those messages.

7. The data transmission architecture according to claim 1, wherein at least one looped peripheral data transmission network assumes the form of a looped network for the conditional transmission of messages from node to node, dependent on those messages.

8. The data transmission architecture according to claim 1, wherein at least some of the data transmission networks are unidirectional.

9. The data transmission architecture according claim 1, wherein at least some of the data transmission networks are bidirectional.

10. The data transmission architecture according to claim 1, wherein the functional nodes of the peripheral networks connected to the main network comprise a extracting/injecting/monitoring capability for frames of and in the latter, to or from the main data transmission network.

11. The data transmission architecture according to claim 1, wherein at least some of the functional nodes are programmable.

12. The data transmission architecture according to claim 10, wherein the frame extracting/injecting/monitoring capability of the programmable node use a programming database stored in a corresponding storage capability.

13. The data transmission architecture according to claim 2, wherein the main network and the peripheral data transmission networks include data transmission supports that are completely or partially redundant associated by redundancy plane.
